(19) United States
(12) Patent Application Publication
(10) Pub. No.: US 2017/0257216 A1
(43) Pub. Date: Sep. 7, 2017

(54) Communicating Between Applications

(71) Applicant: Microsoft Technology Licensing, LLC, Redmond, WA (US)

(72) Inventor: Massimo Perga, London (GB)

(73) Assignee: Microsoft Technology Licensing, LLC, Redmond, WA (US)

(21) Appl. No.: 15/135,105

(22) Filed: Apr. 21, 2016

(30) Foreign Application Priority Data
Mar. 4, 2016 (GB) 1603807.7

(51) Int. Cl. H04L 9/32; H04L 29/08; H04W 12/06; H04L 29/06; G06F 21/44

(52) U.S. Cl. CPC H04L 9/32; H04L 63/08; G06F 21/44; H04W 12/06; H04L 63/0428; H04L 67/10

(57) ABSTRACT

A first application invokes a first URI specifying a second application as the destination of the first URI. The first URI contains a return URI specifying the first application as the destination of the return URI, and the first URI further specifies an action of returning data from the second application. In response to the invocation of the first URI by the first application, the second application checks that the destination specified by the return URI corresponds to a trusted partner in a set of trusted partners, and on condition that the return URI does indeed correspond to one of the trusted partners in the set, it invokes the return URI in order to return the data to the first application. The return URI uses a secure protocol which authenticates an identity of the destination specified by the return URI, and which returns the data over an encrypted channel.

### RELATED APPLICATIONS

This application claims priority to Great Britain Application No. 1603807.7 entitled “Communication Between Applications, filed Mar. 4, 2016, the disclosure of which is contained herein in its entirety by reference.

### BACKGROUND

A uniform resource indicator (URI) is a string of characters used to identify a resource such as an application. Thus, amongst other uses, URIs enable a first application to initiate an action by a second application. To do this, the first application invokes the URI via the operating system on which the first application is running, i.e. by indicating the URI in a request to the operating system so that in response the operating system calls upon the second application. The second application may be running on the same instance of the operating system on the same user terminal as the first application, or alternatively may be run on a remote terminal in which case the URI causes it to be contacted via a suitable network such as the Internet.

A URI comprises a left-most portion called the “scheme” which identifies the resource, in this case the application. Optionally the URI also comprises one or more further portions which qualify the action to be taken in response to the URI. An example is the “mailto” URI scheme which when invoked by, say, a web browser, calls upon an email client in order to open a new email. For instance, invoking the following URI would open a new email to a user Dave Example whose email address is dave@example.com.

mailto:dave@example.com

A URI can be associated with a particular application. When a new application is first installed on a given user terminal, it can register its URI scheme with a list of custom URI schemes recognized by the operating system on that terminal. Another application can then initiate an action by that application by invoking a URI comprising the registered URI scheme. For example, say a company called Acme runs an internet-based communication service and provides a corresponding communication client application for conducting communications such as VoIP calls and/or instance messaging (IM) via said service. Say also that this company is allocated the URI scheme “acme”. When the communication client is installed it registers the URI acme with the operating system's list of custom URI schemes. Another application can then launch the communication client by invoking the following URI.

acme:

Or if Dave's username within the communication system is dave_example, the other application can then initiate a default action in relation to Dave, e.g. a voice over IP (VoIP) call, by invoking the following URI.

acme:dave_example

A mobile deep link is a URI that links to a specific function within an application, rather than simply launching an application generally. Examples would be as follows.

| | |
|---|---|
| acme : dave_example?chat | initiates an IM chat session |
| | with Dave |
| acme : dave_example?call&video=true | initiates a video call with Dave |
| acme : dave_example?profile | views Dave's profile |

The term “mobile deep links” refers to the use of such links in the context of one or both of the applications being a mobile applications run on a mobile terminal (whether the same mobile terminal or different ones), but a similar mechanism can also be used by applications run on one or more static terminals, or to implement interactions between mobile and static terminals.

A uniform resource locator (URL) is a URI that, as well as identifying a resource, specifies a particular means of acting in relation to it. An example of a URL scheme is http, which specifies that communications with the resource resulting from invocation of the URL shall be conducted according to Hypertext Transfer Protocol (HTTP). Another example of a URL scheme is https, which specifies that communications with the resource resulting from invocation of the URL shall be conducted according to the HTTPS (HTTP Secure) protocol. In the latter case, the application being linked to is authenticated before communications can proceed, and when they do, the communicated data is encrypted according to a cryptographic standard such as TLS (Transport Layer Security) or SSL (Secure Socket Layer).

If a first application links to a second application via a URL in the form of an HTTP or HTTPS link, an advantage of this is that it provides a web fall-back in case the second application is not available locally on the same terminal as the first application. When the URL is invoked the operating system checks whether it has the respective URL scheme in its register of custom URI schemes. If so, it calls upon the local instance of the application installed on the same terminal as the first application to perform the desired action. If not however, it either downloads an instance of the second application from the web or calls upon a web-hosted version of the second application in order to perform the action in question (optionally after prompting the user with an option to do one of these). An example would be:

https://call.acme.com/dave_example

The first application invokes this URL in order to initiate a voice call (e.g. VoIP) with Dave Example via the Acme communication service. In response the operating system checks whether the there is a locally installed instance of the Acme client. If so, the operating system launches the local acme client (or switches to it if already running in a background state) and passes it at least an indication of the requested action (in this case a call) and the target of the action (the username “dave_example”). In turn the local instance of the Acme client sends a call establishment request to the remote instance of the Acme client running on the Dave's user terminal and, if Dave accepts, proceeds to conduct the call.

If however the operating system finds, when the URL is invoked, that there is no local instance of the Acme client installed locally on the same user terminal as the first application and the operating system, then the operating system instead uses the URL to contact the Acme server to either download an instance of the Acme client (and then proceed as outlined above), or to send the call establishment request and conduct the call via a web-hosted version of the Acme client. The user may be prompted before doing this.

Another known mechanism is for a URI to contain a return URI. That is, a first application invokes a URI to a second application, wherein that URI itself contains a further, embedded URI which specifies the first application as the destination resource of the embedded URI. For instance, in the case where the second application is a communication client such as a VoIP and/or IM client, a known use of this is for the first application to retrieve a conversation history of past communications conducted through the communication client.

### SUMMARY

However, there is a consideration to be taken into account, in that the information to be shared between applications may be personal or sensitive in nature. For example this could comprise contact information, profile information, presence information and/or a private conversation history.

According to one aspect disclosed herein there is provided an apparatus comprising a first application and a second application, the first and second applications being arranged to communicate based on a system of uniform resource indicators (URIs), each URI specifying a respective destination. The first application is configured to invoke a first URI which specifies the second application as the destination of the first URI, the first URI containing a return URI specifying the first application as the destination of the return URI, and the first URI further specifying an action to be taken by the second application, said action comprising returning data from the second application to the destination specified by the return URI. The second application is configured so as, in response to the invocation of the first URI by the first application, to check that the destination specified by the return URI corresponds to a trusted partner in a set of one or more trusted partners, and on condition that the return URI does indeed correspond to one of the trusted partners in said set, to enact said action by invoking the return URI in order to return the data to the first application based on the destination specified by the return URI. Furthermore, the return URI uses a secure protocol, which authenticates an identity of the destination specified by the return URI before performing the return of said data, and which performs the return of said data over an encrypted channel.

In embodiments, the first URI may also use a secure protocol. This therefore authenticates an identity of the destination specified by the first link before sending the return URI and an indication of said action from the first application to the second application, and performs said sending over an encrypted channel.

For instance, in embodiments the secure protocol used by one or both of the first and second URIs may be HTTPS. In embodiments each of the first and second URIs may be a uniform resource locator (URL). In embodiments, the first URI may be a mobile deep link. In embodiments, the encrypted channel used by one or both of the first and second URIs may be based on SSL or TLS.

In embodiments, the apparatus comprises a user terminal and the first and second applications are both installed on said same user terminal. In such embodiments, the user terminal further comprises an operating system; and the operating system may be configured so as, when the first application invokes the first URI, to perform operations of: (a) checking for a local instance of the second application installed on the user terminal; (b) if found, performing the invocation of the first URI using the local instance of the second application; but (c) if the local instance is not found, performing the invocation of the first URI using a web-hosted instance of the second application or by downloading an instance of the second application to the user terminal from the Internet.

In embodiments, the operating system may be configured so as when the second application is initially installed on the user terminal, to perform operations of: (i) contacting a server via the Internet in order to obtain an allocated ID for the second application; (ii) checking if the allocated ID matches an inherent ID of the second application; and (iii) on condition of said match, registering with operating system as being available for local invocation; wherein said finding of the local instance on the user terminal may be made conditional on said registration.

In alternative embodiments the first and second applications may be implemented on different terminals. For instance, the first application may be implemented on a user terminal but said second application may be implemented on a portable device separate from said user terminal, but paired with the user terminal via a local wireless connection. E.g. the portable device may take the form of a handheld device such as a tablet or smartphone, or a wearable device such as a smartwatch or smart-glasses.

In embodiments, the second application may be a communication client application for enabling a near-end user, being a user of the communication client application, to conduct communications with one or more far-end users over the Internet. For instance the communications may comprise any one or more of: live voice calls, live video calls, instant messaging, picture messaging, video messaging, audio messaging, screen sharing, remote presentations, and/or a virtual whiteboard. In such embodiments or similar, the data being shared from the communication client to the first application may be personal information of any of: the near-end user, one or more of the far-end users, and/or one or more contacts of the near-end user. E.g. the personal information comprises any one or more of: a contact list of the near-end user, a profile of the near-end user, a profile of one or more or the far-end-users and/or contacts, presence information of one or more of the far-end users and/or contacts, and/or a history of one or more of past communications conducted via the communication client application involving the near-end user.

In embodiments, the communication client may be configured to retrieve said data via internet in order to be able to perform said return of the data to the first application (e.g. to retrieve the contact list, profile information, presence status and/or conversation history from a server of the communication service).

In embodiments, the apparatus may take the form of an in-car console and the first application may be a car console application arranged to run on the in-car console. In the case where the first and second applications are implemented on the same terminal, then both may be implemented on the in-car console. In the case where the first application is implemented on a first terminal while the second application is implemented on a second terminal separate from the first, then the first terminal may be the in-car console and the second terminal may take the form of a portable device such as a laptop, tablet, smartphone, smartwatch or smart-glasses.

The disclosed techniques can also be applied to other types of applications and to applications running on other types of terminal.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put in effect, reference is made by way of example to the accompanying drawings in which:

FIG. 1 is a schematic block diagram of a communication system, and

FIGS. 2a and 2b are schematic mock-ups of a user interface.

### DETAILED DESCRIPTION OF EMBODIMENTS

Consider a scenario in which company P wants to become a trusted partner of company A in order to create an experience where their two applications share some personal data. For example company P's application could be a car-console application for running on an in-car console (e.g. dashboard console), while company A's application may be a communication client application such as a VoIP and/or IM client. In such as case the personal information shared from the communication client to the car console application could be for example a contact list, user profile information and/or presence information. However, it would be desirable if such information could be shared securely. Similar considerations may apply to sharing sensitive data between other types of application.

The following describes a solution in which both company P and company S use mobile deep links based on top of the HTTPS protocol. Company P registers itself with company A, and company A enters company P and its domain for mobile deep links in its internal system as a trusted partner. When the application for company P wants to trigger an action in the application for company A and this action will return personal data, then the application for company P is required to include a “call-back” URL (i.e. return URL) using the HTTPS protocol into the mobile deep link request.

In this way, whenever the application of company A is invoked using a mobile deep link and the action is expected to return personal data, the application of company A—before processing the action—will validate with a service internal to company A (e.g. a database) whether the domain belongs to a trusted partner who is authorized to get access to the personal data returned by company A's application.

For example, say company A's application is a communication client application for accessing inter-user communication services such as live voice calling, video calling and/or IM chat. Company A's application may provide support for URIs and mobile deep linking. Both these technologies can be used to initiate actions on A's client for the user who is currently logged in. For instance, as discussed, it is possible to start a chat between the current user logged into the communication client and a remote user dave_example by simply calling this URI: acme:dave_example?chat.

However, even current mobile deep linking solutions (URIs relying on the HTTP or HTTPS scheme), developed to support integration with other applications such as an email client, support active actions only. In order to have fully functional interaction between two applications using a URI-based technology, a mechanism is required to allow notifications from the application executing the actions. One way to implement this support is to add a callback URI as part of the original URI containing the action, in such a way that—when the action is completed—the callee application will open the callback URI supplied to the original URI.

It is likely that notifications will contain information about contacts and conversations from the A's client, and A will want to respect the personal data for its customers.

Operating systems have implemented mechanisms that can guarantee that the identity of the entity which will execute the mobile deep link; for instance, with the mobile deep link being based on top of HTTPS, it is known that an HTTPS mobile deep link for https://join.acme.com will always be executed either by A's client or by the web fall-back experience available at that URL.

However, one issue with this approach is that one cannot restrict usage of mobile deep linking functionalities exposing personal data only to certain trusted partners. To address this, it would be desirable to enable two trusted parties exchanging data under controlled access.

Thanks to the HTTPS protocol, both company A and company P ensure that the communication between them is happening on a secure channel, and there's no risk of “man in the middle” attack. Despite that, “P” could in fact be any party implementing a HTTPS mobile deep link which inserts its URL into a callback for an action towards the application for company A.

Accordingly, in embodiments disclosed herein, A's application is configured to check the domain part of the callback URL against a list of trusted partners before returning any personal information, thereby ensuring that the callback will disclose data only to a trusted partner.

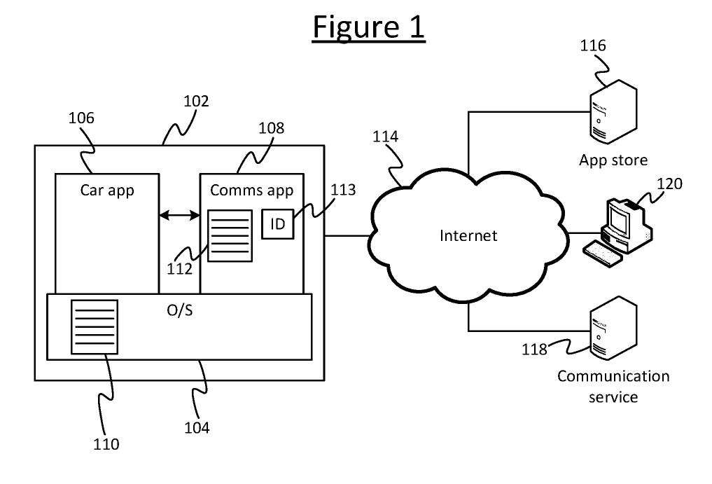

FIG. 1 illustrates an example communication system in accordance with embodiments of the present disclosure.

The system comprises a user terminal 102 configured to connect to a network 114. The user terminal 102 may take any of a variety of forms, e.g. a desktop computer; or a console of a vehicle such as an in-car console; or a portable user terminal such as a laptop, tablet, smartphone, smartwatch or smart-glasses. In one particular embodiment the user terminal 102 takes the form of the dashboard console of a car. The dashboard console comprises a display device which may comprise a display screen embedded in the dashboard and/or which may comprise a head-up display configured to project a graphical display onto the front windshield of the car. The dashboard console also comprises one or more user input devices, typically mounted on the dashboard, e.g. directly on the dashboard (e.g. buttons and/or a selector wheel), and/or mounted indirectly on the dashboard such as buttons on the steering wheel or stalks (the wheel in turn being mounted on the dashboard). The input devices of the dashboard may also include a remote control device so that it can be controlled by a passenger from the back seat.

The network 114 preferably takes the form of a wide are internetwork such as that commonly referred to as the Internet. The user terminal 102 may be configured to connect to the Internet 114 via any suitable means: the user terminal 102 may comprise a wired interface configured to connect to the network 114 via a wired connection, e.g. via a landline or wired local area network such as a local Ethernet network; or more preferably the user terminal 102 may comprise a wireless interface configured to connect to the Internet 114 via a wireless connection, e.g. via a wireless access point, wireless home router, wireless local area network (WLAN), or wireless cellular network. For instance the wireless interface may operate according to any local (short range) radio frequency (RF) technology such as Wi-Fi or Bluetooth. In the case where the user terminal 102 is a dashboard console or other on-board console of a vehicle then the interface is a wireless interface for connecting to the Internet by wireless means, e.g. a cellular interface for connecting via a mobile cellular network such as a 3GPP based network. Any of the external communications discussed herein may be implemented any of the above-mentioned communications means and/or others, and for brevity the different possibilities will not be repeated each time.

The user terminal 102 is installed with an operating system 104, a first application 106, and a second application 108. That is, each of these is stored on a memory of the user terminal 102 (comprising one or more memory units, e.g. magnetic and/or electronic memory units) and is arranged to run on a processor of the user terminal 102 (comprising one or more processing units, e.g. one or more cores or one or more separate processing chips). In embodiments where the user terminal 102 is an in-car console, the first application 106 may take the form of a car console application. The first application 106 is provided by a first software provider, e.g. the car manufacturer, while the second application 108 is provided by a second software provider who wishes to adopt the first provider as a partner. For example the second application 108 may be a communication client application such as a VoIP and/or IM client, and the second software provider may be a provider of a corresponding VoIP and/or video service. By the communication client application 108 running on the user terminal 102, this thereby enables the user of the user terminal 102 to conduct inter-user communication sessions such as VoIP calls and/or IM conversations with at least one remote terminal 120, via the Internet 104. In embodiments these communications may be relayed via a sever 118 operated by the provider of the communications service, or alternatively a peer-to-peer (P2P) topology may be used.

Consider the following scenario. The provider of the second application 108 wishes to partner with the provider of the first application 106. E.g. the communication service provider wishes to take on the car manufacturer as a partner, so that the user can access at least some of the communications services it provides via the car dashboard console and car console application (the first application) 106 of the car manufacturer's cars. Furthermore, the communication service provider does not wish to have to provide much, if any, code to be embedded intrinsically within the first application 106. Therefore a mechanism will be needed to communicate between the second application 108 and the first application 106. In fact, it would be desirable to provide as minimal and universal an interface as possible, to facilitate interoperability with as many potential counterparts as possible.

However, this will mean the second application 108 will have to share some personal information from the communication service 118 with the first application 106, e.g. the user's contact list, conversation history, account settings, the use's own profile, and/or the profiles of the user's contacts (the contacts being other users of the communication service with which the user in question has mutually agreed to become contacts with). Most application providers will want to be able to protect their users' personally identifiable information (PII).

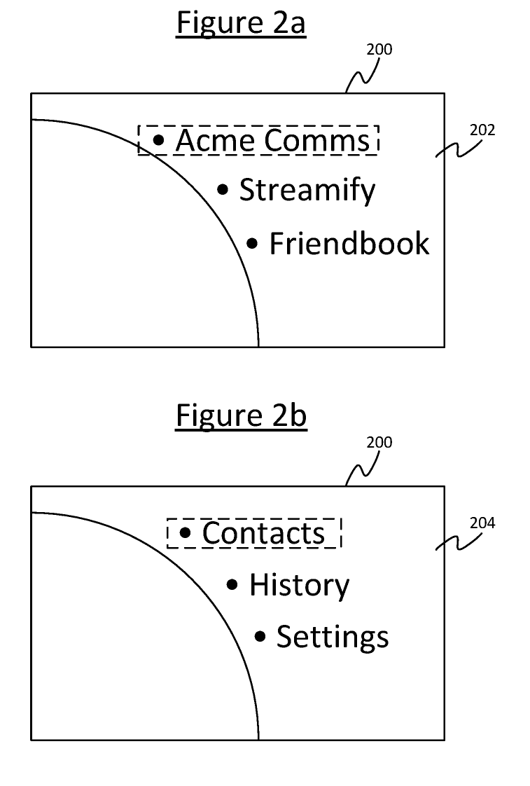

An example is illustrated in FIGS. 2a and 2b. FIG. 2a illustrates the user interface of the first application 108, e.g. displayed on a display screen on the dashboard or on an HUD. The user interface comprises a first menu 202 providing the user with a list of applications from providers who have partnered with the first provider, e.g. car manufacturer. These comprise the communication client application 102 (“Acme Communications” in the illustrated example) and one or more other applications, e.g. a music streaming application for streaming music from the Internet 114 to be played out via the car's sound system, and/or a social networking application allowing social networking feeds or other such information to be viewed via the first application 106 and in-car console 102. The user interface 102 also comprises a selection mechanism such as a cursor or voice control enabling the user to select one of the applications.

When the user selects the communication client application 108 from the first menu 202, the user interface then presents the user with a second menu 204 as shown in FIG. 2b. The second menu 204 comprises a list of options relating to the communication service (again from which the user can select using the selection mechanism, e.g. cursor or voice recognition). For instance, the options could include an option to summon a contact list (from which the user can then select a contact with whom to initiate communication, e.g. to request a VoIP call or to send an IM chat message). Alternatively or additionally, the options may include an option to summon a conversation history, comprising a history of one or more past communications with one or more contacts. As another alternative or additional possibility, the options may include an option to access account settings of the user. When selected, the communication client 108 retrieves the selected information from the server 118 of the communication service and shares it with the dashboard application 106 in order for that information to be displayed to the user via the user interface 200 on the display (e.g. dashboard display or HUD) of the dashboard console 102. Note also that audio output of the information is also possible, especially for an in-car application.

In order to enable the second application 106 to share personal information or other sensitive information securely with the first application 106, it is desirable that the second application 108 should verify the first application 106 before doing so, in order to prevent a malicious third party application from masquerading as the first application 106 in order to maliciously extract the information. It is also preferable that the information is shared in a manner that avoids man-in-the-middle attacks. The following describes an example technique for achieving these ends.

The operating system 104 is configured so as, upon the initial installation of the communication client application 108, the operating system 104, to contact (over the Internet 114) a web server 116 whose URL is declared in the communication client application 108 as supported by the application, e.g. an app store server from which the communication client 106 was obtained. The operating system does this in order to retrieve an ID allocated by the server (e.g. by the app store) for the communication client application. The operating system 104 is configured to then compare this against a local, inherent (i.e. “built-in”) ID of the client application 108 itself. Only if this matches, the operating system 104 then registers the communication client in a custom list of URLs 110 recognized by the operating system 104. That is, the operating system 104 attempts to match the ID of the application 108 claiming to support URLs belonging to a certain web-server 116 with the file downloaded by that web-server 116. The application 108 is considered as “default handler” for URLs towards that web-server 116 only if this last step succeeds; otherwise a web browser running on the operating system will behave as usual, i.e. opening those URLs in its context.

Subsequently, when the dashboard application 106 invokes the URL of the client application 108 in order to perform a certain specified action, the operating system 104 checks to see if the communication client application's URL is recognized in the custom list 110. If it is, the operating system 104 calls upon the locally installed instance of the communication client application 108 to perform the action (e.g. return the user's contact list to the car app, or profile information of a particular contact). If the locally installed instance is not present however (at least not according to said list 110), then the operating system 104 calls to a web fall-back experience provided by the communication service provider's server 118. The web fall-back experience may be to perform the action from a web-hosted instance of the communication client application, or to download the communication client application 108 to the console 102 so that the action can then be performed locally after all.

Say the car company has a domain carco.com. The in-car application 106 can trigger an action by the communication client 108 by invoking a URL such as:

https://contacts.acme.com/all&x-success=https://carapp.carco.com/showindashboard
to summon a list of the user's contacts, or
https://profile.acme.com/dave_example&x-success=https://carapp.carco.com/showindashboard
to summon the profile of a particular contact with username dave_example (the profile comprising e.g. Dave's contact details, presence, profile picture and/or status message).

The communication client application 108 maintains a list of trusted contacts 112. When it receives the request, the communication client 108 checks that the domain carco.com is included in said list. Only if it is, the communication client 108 returns the request information to the dashboard application 106 to be displayed to the user via the display of the console 102.

However, if a malicious third party with domain bad.com attempts to do the same thing, e.g.:

https://contacts.acme.com/all&x-success=https://maliciousapp.bad.com/maliciousaction
the domain bad.com will not be recognized in the list of trusted partners and so the communication client 108 will not return the requested information.

Furthermore, since the URLs are required to use a secure scheme corresponding to a secure communications protocol, namely HTTPS, then this means (A) the identity of the requesting party Carco is authenticated based on a cryptographic technique as a condition of returning the requested information, and (B) the information is sent back over an encrypted channel. This avoids man-in-the-middle attaches. Without the latter, a malicious third party could send a request using the legitimate carco.com domain as the return URL but then eavesdrop on the reply. But as the reply is encrypted, this is not possible (or at least not feasible to decrypt in practical terms).

Note: while HTTPS authenticates the destination resource before sending data, additional security is added by imposing the list of trusted partners 112 as well. To see why, consider the following scenario.

Suppose that the second application 108 handles https://www.acme.com and the first application 106 handles https://www.carco.com. Based on the above-described techniques, if the first application 106 requests the second application 108 to perform a certain action and then to be called back by the second application 108, this will be done with a URL having a format such as: https://www.acme.com?<action to perform>&<parameters about the action to perform>&<how to call back the car app, i.e. something like https://www.carco.com<?action to perform on the email client>&<parameters as before>>.

Thus the first application 106 asks the second application 108 to perform an action (hence the URL domain is www.acme.com) and the way in which it calls back is encoded in the original URL. However, the operating system 104 does not care about what's in the URL. Rather, only the receiving application 108 cares as it's the handler for that action.

What the operating system 104 guarantees is that if one calls a https://www.acme.com URL then the content will be handled for sure by the VoIP client or service, and if one calls a https://www.carco.com URL then the content will be handled for sure by the car application or company (in the case where it's the VoIP application calling the car application because the URL is embedded into the original one).

What the operating system 104 does not provide is a check about the domain originally passed to the URL for the call-back. I.e. whilst the operating system 104 checks that the content will be indeed handled by the domain specified in the return URL, it does not check whether that domain is a desirable party to have access to the disclosed information. Therefore according to the present disclosure, this check is performed in the VoIP application (or second more generally application 108).

For instance, consider that a malicious party creates a malicious app handling “bad.com” and is aware of the call-back mechanism. Without the check against the trusted list 112, the malicious party could simply call: https://www.acme.com?<action to perform>&<parameters about the action to perform>&<how to call back, i.e. something like https://www.maliciousapp.bad.com<?action>&<as before>>. This would grab some PII data from the VoIP user and the operating system 104 would still allow this because it is only guaranteeing that the app handling bad.com is properly invoked. I.e. the operating system 104 only guarantees that the data is indeed returned securely to bad.com and not elsewhere, but does not check whether bad.com is a suitable party to have the data.

Therefore HTTPS guarantees that there is no man-in-the-middle attack, but it is the responsibility of the callee (second) application 108 (the VoIP app in the above examples) to guarantee that the return destination is allowed. Put another way, HTTPS does not guarantee how the first application 106 is going to use the data, only that the web-site or destination resource has a known identity. To address this the disclosed techniques provide a mechanism that enforces the second application 108 to validate the first application 106 as being one of the applications allowed to receive data from it.

It will be appreciated that the above embodiments have been described only by way of example.

For instance, the scope of the present disclosure is not limited to a combination of an in-car application and a VoIP and/or IM client. As another example, the second application may be a social media application sharing information such as a social media feed, photos or contact information with a first application in any form, whether it be an in-car console application as described previously, or another kind of application such as a TV application running on a set-top box, or game application on a games console.

Further, the first and second applications 106, 108 don't necessarily have to be implemented on the same terminal 102, and instead the first application 106 may be implemented on a first user terminal while the second application 108 may be implemented on a second user terminal. In embodiments, the two terminal may be paired via a local wireless connection such as via a wireless local area network, thus enabling the second application 108 to communicate with the first application 106 to perform the exchanges disclosed herein. In such cases the wireless connection may use any suitable wireless technology such as Wi-Fi or Bluetooth. One or both of the first and second terminals may take the form of portable terminal such as a laptop, tablet, smartphone, smartwatch or smart-glasses. For instance, in one example use case the first terminal is an in-car console (e.g. dashboard console) and the second terminal is a handheld or wearable terminal. When the user approaches or enters his or her car, the second terminal pairs with the in-car console and thus enables the second application to provide communication services such as VoIP and/or IM services via the first application and in-car consult.

Note also that the term “car” should be interpreted broadly herein to refer to any self-locomotive road-going vehicle, e.g. a hatchback (compact), estate (station wagon), saloon, coupe, supermini, minivan, SUV, pickup, van, lorry (truck), or tractor.

Further, while the above has been described in terms of communications over the Internet, in alternative embodiments the network 114 may take other forms, such as an intranet within an organization such as a company or university.

Further, the scope of the present disclosure is not limited to any specific type of URI or protocol. Where a secure protocol is to be employed, the teachings disclosed herein may be implemented using any secure protocol which imposes authentication and encryption to communicate between one application and another.

Further, note that the term server as used herein refers to a logical entity that may be implemented on one or more physical server units at one or more geographical sites.

Other variants may be apparent to a person skilled in the art once given the disclosure herein. The scope of the present disclosure is not limited by the described embodiments but only by the accompanying claims.

1. Apparatus comprising a first application and a second application, the first and second applications being arranged to communicate based on a system of uniform resource indicators (URIs), each URI specifying a respective destination;
wherein the first application is configured to invoke a first URI which specifies the second application as the destination of the first URI, the first URI containing a return URI specifying the first application as the destination of the return URI, and the first URI further specifying an action to be taken by the second application, said action comprising returning data from the second application to the destination specified by the return URI;
wherein the second application is configured so as, in response to the invocation of the first URI by the first application, to check that the destination specified by the return URI corresponds to a trusted partner in a set of one or more trusted partners, and on condition that the return URI does indeed correspond to one of the trusted partners in said set, to enact said action by invoking the return URI in order to return the data to the first application based on the destination specified by the return URI; and
wherein the return URI uses a secure protocol which authenticates an identity of the destination specified by the return URI before performing the return of said data, and which performs the return of said data over an encrypted channel.

2. The apparatus of claim 1, wherein the first URI uses a secure protocol, which authenticates an identity of the destination specified by the first link before sending the return URI and an indication of said action from the first application to the second application, and which performs said sending over an encrypted channel.

3. The apparatus of claim 1, wherein the secure protocol used by one or both of the first and second URIs is HTTPS.

4. The apparatus of claim 1, wherein each of the first and second URIs is a uniform resource locator (URL).

5. The apparatus of claim 1, wherein the first URI is a mobile deep link.

6. The apparatus of claim 1, wherein the encrypted channel for one or both of the first and second URIs is based on SSL or TLS.

7. The apparatus of claim 1, wherein the apparatus comprises a user terminal and the first and second applications are both installed on said same user terminal.

8. The apparatus of claim 7, wherein the user terminal further comprises an operating system; and wherein the operating system is configured so as, when the first application invokes the first URI, to perform operations of:
checking for a local instance of the second application installed on the user terminal;
if found, performing the invocation of the first URI using the local instance of the second application; but
if the local instance is not found, performing the invocation of the first URI using a web-hosted instance of the second application or by downloading an instance of the second application to the user terminal from the Internet.

9. The apparatus of claim 8, wherein the operating system is configured so as when the second application is initially installed on the user terminal, to perform operations of:
contacting a server via the Internet in order to obtain an allocated ID for the second application;
checking if the allocated ID matches an inherent ID of the second application; and
on condition of said match, registering the second application with the operating system as being available for local invocation;
wherein said finding of the local instance on the user terminal is conditional on said registration.

10. The apparatus of claim 1 wherein the first application is implemented on a user terminal but said second application is implemented on a portable device separate from said user terminal, but paired with the user terminal via a local wireless connection.

11. The apparatus of claim 1, wherein said data comprises personal information.

12. The apparatus of claim 1, wherein the second application is a communication client application for enabling a near-end user, being a user of the communication client application, to conduct communications with one or more far-end users over the Internet.

13. The apparatus of claim 12, wherein the communication client application is an application for conducting said communications in the form of any one or more of: live voice calls, live video calls, instant messaging, picture messaging, video messaging, audio messaging, screen sharing, remote presentations, and/or a virtual whiteboard.

14. The apparatus of claim 13, wherein said data comprises personal information of the near-end user, one or more of the far-end users, and/or one or more contacts of the near-end user.

15. The apparatus of claim 14, wherein the personal information comprises any one or more of: a contact list of the near-end user, a profile of the near-end user, a profile of one or more or the far-end-users and/or contacts, presence information of one or more of the far-end users and/or contacts, and/or a history of one or more of past communications conducted via the communication client application involving the near-end user.

16. The apparatus of claim 1, wherein the communication client is configured to retrieve said data via internet in order to be able to perform said return of the data to the first application.

17. The apparatus of claim 1, wherein the apparatus is an in-car console and the first application is a car console application arranged to run on the in-car console.

18. The apparatus of claim 17 as dependent on any of claims 7 to 10, wherein said user terminal is the in-car console.

19. A method of communicating between a first application and a second application, based on a system of uniform resource indicators (URIs), each URI specifying a respective destination; the method comprising:
from the first application, calling a first URI which specifies the second application as the destination of the first URI, wherein the first URI contains a return URI specifying the first application as the destination of the return URI, and wherein the first URI further specifies an action to be taken by the second application, said action comprising returning data from the second application to the destination specified by the return URI;
at the second application, in response to said calling of the first URI by the first application, checking that the destination specified by the return URI corresponds to a trusted partner in a set of one or more trusted partners, and on condition that the return URI does indeed correspond to one of the trusted partners in said set, enacting said action by calling the return URI in order to return the data to the first application based on the destination specified by the return URI;
wherein the return URI invokes use of a secure protocol which authenticates an identity of the destination specified by the return URI before performing the return of said data, and which performs the return said data over an encrypted channel.

20. A suite of applications comprising at least a first application and a second application, each application comprising code embodied on a computer-readable storage;
wherein the code of the first application is configured so as when run on one or more processing units to invoke a first URI which specifies the second application as the destination of the first URI, the first URI containing a return URI specifying the first application as the destination of the return URI, and the first URI further specifying an action to be taken by the second application, said action comprising returning data from the second application to the destination specified by the return URI;
wherein the second application is configured so as when run on one or more processing units then, in response to the invocation of the first URI by the first application, to check that the destination specified by the return URI corresponds to a trusted partner in a set of one or more trusted partners, and on condition that the return URI does indeed correspond to one of the trusted partners in said set, to enact said action by invoking the return URI in order to return the data to the first application based on the destination specified by the return URI; and
wherein the return URI uses a secure protocol which authenticates an identity of the destination specified by the return URI before performing the return of said data, and which performs the return of said data over an encrypted channel.
